(19) United States
(12) Patent Application Publication
(10) Pub. No.: US 2026/0066926 A1
(43) Pub. Date: Mar. 5, 2026

(54) IQ PASSIVE MIXER WITH ENHANCED CONVERSION GAIN

(71) Applicant: STMicroelectronics International N.V., Geneva (CH)

(72) Inventor: Alessandro VENCA, Hauterive (CH)

(73) Assignee: STMicroelectronics International N.V., Geneva (CH)

(21) Appl. No.: 19/302,520

(22) Filed: Aug. 18, 2025

(30) Foreign Application Priority Data
Aug. 28, 2024 (FR) FR2409174

(51) Int. Cl. H04B 1/00; H04B 1/04

(52) U.S. Cl. CPC H04B 1/0028; H04B 1/0458

(57) ABSTRACT

An IQ mixer includes a mixing stage with a first mixer and a second mixer. A first inductive block is coupled to the first mixer and includes at least a first inductive component. A second inductive block is coupled to the second mixer and includes at least a second inductive component.

### PRIORITY CLAIM

This application claims the priority benefit of French Application for Patent No. FR2409174, filed on Aug. 28, 2024, the content of which is hereby incorporated by reference in its entirety to the maximum extent allowable by law.

### TECHNICAL FIELD

The present disclosure relates generally to an IQ passive mixer.

### BACKGROUND

A radiofrequency receiver generally comprises an IQ mixer to down-convert a radiofrequency current into baseband currents in quadrature. An IQ mixer is typically made with transistors. The conversion gain of the IQ mixer corresponds to the ratio between the baseband current and the radiofrequency current.

There is a need to have a high conversion gain.

There is a need to address all or some of the drawbacks of known IQ passive mixers.

### SUMMARY

One embodiment provides an IQ mixer comprising: a mixing stage comprising a first mixer and a second mixer; and a first inductive block coupled to the first mixer and comprising at least a first inductive component and a second inductive block coupled to the second mixer and comprising at least a second inductive component.

According to an embodiment, the mixing stage comprises a first input, a second input, a first output, a second output, a third output, and a fourth output. The first mixer is connected to the first input, the second input, the first output, and the second output. The second mixer is connected to the first input, the second input, the third output, and the fourth output. The first inductive block is connected to the first output and the second output. The second inductive block is connected to the third output and the fourth output.

According to an embodiment, the first inductive block comprises a first inductor having first and second terminals, the first terminal being connected to the first output, and a second inductor having third and fourth terminals, the third terminal being connected to the second output.

According to an embodiment, the first inductive block further comprises a first capacitor connected between the second terminal and the fourth terminal.

According to an embodiment, the first inductive block comprises a third inductor having fifth and sixth terminals, a second capacitor connected between the first output and the fifth terminal, and a third capacitor connected between the second output and the sixth terminal.

According to an embodiment, the first inductive block further comprises a fourth capacitor connected between the first output and the second output.

According to an embodiment, the first inductive block comprises a transformer comprising a fourth inductor connected between the first output and the second output and a fifth inductor coupled with the fourth inductor.

According to an embodiment, the first mixer comprises: a first MOS transistor whose drain is coupled to the first output and whose source is connected to the first input; a second MOS transistor whose drain is connected to the second output and whose source is connected to the first input; a third MOS transistor whose drain is connected to the first output and whose source is connected to the second input; and a fourth MOS transistor whose drain is connected to the second output and whose source is connected to the second input.

According to an embodiment, the second mixer comprises: a fifth MOS transistor whose drain is connected to the third output and whose source is connected to the first input; a sixth MOS transistor whose drain is connected to the fourth output and whose source is connected to the first input; a seventh MOS transistor whose drain is connected to the third output and whose source is connected to the second input; and an eighth MOS transistor whose drain is connected to the fourth output and whose source is connected to the second input.

Another embodiment provides a radiofrequency receiver comprising an antenna, a first amplifier coupling the antenna to the mixing stage of an IQ mixer as previously defined, a second amplifier coupled to the first inductive block of the IQ mixer, and a third amplifier coupled to the second inductive block of the IQ mixer.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 is a block diagram of a radiofrequency receiver comprising an IQ mixer;

FIG. 2 is a block diagram of a part of the receiver of FIG. 1 with the IQ mixer in a differential configuration;

FIG. 3 is a block diagram of an example of an IQ passive mixer of the receiver of FIG. 2;

FIG. 4 is a block diagram of an embodiment of the IQ mixer of FIG. 1;

FIG. 5 shows an amplitude spectrum of a purely resistive load;

FIG. 6 shows an amplitude spectrum of the impedance seen by the mixing stage of the IQ mixer of FIG. 4;

FIG. 7 is a block diagram of an embodiment of an inductive block of the IQ mixer of FIG. 4;

FIG. 8 shows an amplitude spectrum of the impedance seen by the mixing stage of the IQ mixer of FIG. 4 having the inductive blocks of FIG. 7;

FIG. 9 is a block diagram of the receiver of FIG. 1 with the IQ mixer of FIG. 4 having the inductive blocks of FIG. 7 showing the parameters used for performing simulations;

FIG. 10 shows curves of evolution of the conversion gain of the IQ mixer of FIG. 4 having the inductive blocks of FIG. 7 with respect to the inductance of the inductive blocks for three values of resistances;

FIG. 11 shows, in the upper part, the spectrum of the current supplying the IQ mixer of FIG. 2 and shows, in the lower part, the spectrum of the current supplied by the IQ mixer of FIG. 2;

FIG. 12 and FIG. 13 show chronograms of signals during the operation of the IQ mixer of FIG. 2;

FIG. 14 shows, in the upper part, the spectrum of the current supplying the IQ mixer of FIG. 4 having the inductive blocks of FIG. 7 and shows, in the lower part, the spectrum of the current supplied by the IQ mixer of FIG. 4 having the inductive blocks of FIG. 7;

FIG. 15 and FIG. 16 show chronograms of signals during the operation of the IQ mixer of FIG. 4 having the inductive blocks of FIG. 7;

FIG. 17 shows a model for the IQ mixer of FIG. 2 or 5;

FIG. 18 shows chronograms of signals during the operation of the IQ mixer of FIG. 2 or 5;

FIG. 19 show chronograms of signals during the operation of the IQ mixer of FIG. 5;

FIG. 20 is a block diagram of another embodiment of the inductive block of the IQ mixer of FIG. 4;

FIG. 21 shows an amplitude spectrum of the impedance seen by the mixing stage of the IQ mixer of FIG. 4 having the inductive blocks of FIG. 20;

FIG. 22 is a block diagram of another embodiment of the inductive block of the IQ mixer of FIG. 4;

FIG. 23 is a block diagram of the receiver of FIG. 1 with the IQ mixer of FIG. 4 having the inductive blocks of FIG. 22 showing the parameters used for performing simulations;

FIG. 24 shows an amplitude spectrum of the impedance seen by the mixing stage of the IQ mixer of FIG. 4 having the inductive blocks of FIG. 22;

FIG. 25 shows a curve of evolution of the conversion gain of the IQ mixer of FIG. 4 having the inductive blocks of FIG. 22 with respect to the inductance of the inductive blocks;

FIG. 26 shows the spectrum of the current supplied by the IQ mixer of FIG. 4 having the inductive blocks of FIG. 22;

FIG. 27 is a block diagram of another embodiment of the inductive block of the IQ mixer of FIG. 4;

FIG. 28 shows an amplitude spectrum of the impedance seen by the mixing stage of the IQ mixer of FIG. 4 having the inductive blocks of FIG. 27;

FIG. 29 is a block diagram of another embodiment of the inductive block of the IQ mixer of FIG. 4;

FIG. 30 shows an amplitude spectrum of the impedance seen by the mixing stage of the IQ mixer of FIG. 4 having the inductive blocks of FIG. 29;

FIG. 31 shows a curve of evolution of the conversion gain of the IQ mixer of FIG. 4 having the inductive blocks of FIG. 29 with respect to the inductance of the inductive blocks;

FIG. 32 shows the spectrum of the current supplied by the IQ mixer of FIG. 4 having the inductive blocks of FIG. 29;

FIG. 33 is a block diagram of another embodiment of the inductive block of the IQ mixer of FIG. 4; and

FIG. 34 shows an amplitude spectrum of the impedance seen by the mixing stage of the IQ mixer of FIG. 4 having the inductive blocks of FIG. 33.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Furthermore, unless otherwise indicated, when speaking of a voltage at a node, we consider the difference between the potential at said node and a reference potential Gnd, for example ground, taken equal to 0 V.

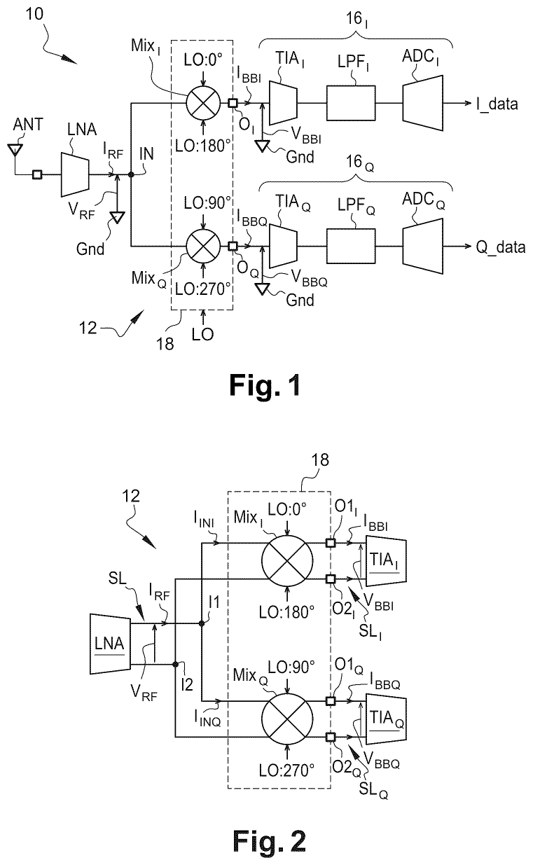

Unless specified otherwise, the expressions “around”, “approximately”, “substantially” and “in the order of” signify within 10% or 10°, and preferably within 5% or 5°. FIG. 1 is a block diagram of a radiofrequency receiver 10.

The radiofrequency receiver 10 comprises: an antenna ANT; a low noise amplifier LNA coupled, preferably connected, to the antenna ANT and providing a current I_{RF} at a node IN having a voltage V_{RF}; an IQ mixer 12 (of direct-conversion type from RF to baseband (BB)) receiving the current I_{RF} and comprising a first (in phase) mixer Mix_{I} providing a current I_{BBI} at a node Or having a voltage V_{BBI} and a second (quadrature phase) mixer Mix_{Q} providing a current I_{BBQ} at a node O_{Q} having a voltage V_{BBQ}; a first treatment (signal processing) chain 161 comprising a first transimpedance amplifier TIA_{I} (having a low impedance at baseband) receiving the current I_{BBI}, a first low-pass filter LPF_{I} coupled to the output of the first transimpedance amplifier TIA_{I}, and a first analog-to-digital converter ADC_{I} coupled to the output of the first low-pass filter LPF_{I} and providing first digital data I_data; and a second treatment (signal processing) chain 16Q comprising a second transimpedance amplifier TIA_{Q} (having a low impedance at baseband) receiving the current I_{BBQ}, a second low-pass filter LPF_{Q} coupled to the output of the second transimpedance amplifier TIA_{Q}, and a second analog-to-digital converter ADC_{Q} coupled to the output of the second low-pass filter LPF_{Q} and providing second digital data Q_data.

The first mixer Mix_{I} and the second mixer Mix_{Q} forms a direct conversion mixing stage 18. The mixing stage 18 receives a periodic oscillating signal LO provided by an oscillator, not shown. The first mixer Mix_{I} receives a first oscillating signal LO: 0°, which is equal to the oscillating signal LO, and a second oscillating signal LO: 180°, which is equal to the oscillating signal LO shifted by 180°. The second mixer Mix_{Q} receives a third oscillating signal LO: 90°, which is equal to the oscillating signal LO shifted by 90°, and a fourth oscillating signal LO: 270°, which is equal to the oscillating signal LO shifted by 270°. The IQ mixer allows to down-convert the radiofrequency current I_{RF} to the lower frequency currents I_{BBI} and I_{BBQ} that are then processed by the treatment chains 16 and 18. As an example, oscillating signal LO corresponds to a square wave signal with a duty cycle equal to 50%. Hereafter, the oscillating signals LO: 0°, LO: 90°, LO: 180°, and LO: 270° are generally also called command signals S_{LO}.

FIG. 2 is a block diagram of a part of the receiver of FIG. 1 with the IQ mixer 12 in a differential configuration.

In other words, the direct conversion IQ mixer 12 has a symmetrical structure. This means that the currents I_{RF}, I_{BBI}, and I_{BBQ} and the voltage V_{RF} are transmitted by symmetrical lines. A symmetrical line is a group of two conductive tracks having exactly the same relationship to ground, carrying an electrical signal, from a source to a load. The voltage V_{RF} corresponds to the voltage between the two conductive tracks of a symmetrical line SL between the low noise amplifier LNA and the IQ mixer 12. The current I_{RF} is the current that circulates through one of the conductive tracks of the symmetrical line SL, the other conductive track of the symmetrical line SL carrying the current −I_{RF}. The voltage V_{BBI} corresponds to the voltage between the two conductive tracks of a symmetrical line SL_{I} between the IQ mixer 12 and the transimpedance amplifier TIA_{I}, and the voltage V_{BBQ} corresponds to the voltage between the two conductive tracks of a symmetrical line SL_{Q} between the IQ mixer 12 and the transimpedance amplifier TIA_{Q}. The current I_{BBI} is the current that circulates through one of the conductive tracks of the symmetrical line SL_{I}, the other conductive track of the symmetrical line SL_{I} carrying the current −I_{BBI}, and the current I_{BBQ} is the current that circulates through one of the conductive tracks of the symmetrical line SL_{Q}, the other conductive track of the symmetrical line SL_{Q} carrying the current −I_{BBQ}.

The mixing stage 18 of the IQ mixer 12 comprises: a first input node I1 connected to the first conductive track of the symmetrical line SL connecting the IQ mixer 12 to the low noise amplifier LNA which provides the RF signal; a second input node I2 connected to the second conductive track of the symmetrical line SL connecting the IQ mixer 12 to the low noise amplifier LNA which provides the RF signal; a first output node O1_{I} connected to the first conductive track of the symmetrical line SL_{I} connecting the IQ mixer 12 which provides the baseband signal to the transimpedance amplifier TIA_{I}; a second output node O2_{I} and connected to the second conductive track of the symmetrical line SL_{I} connecting the IQ mixer 12 which provides the baseband signal to the transimpedance amplifier TIA_{I}; a third output node O1_{Q} connected to the first conductive track of the symmetrical line SL_{Q} connecting the IQ mixer 12 which provides the baseband signal to the transimpedance amplifier TIA_{Q}; and a fourth output node O2_{Q} connected to the second conductive track of the symmetrical line SL_{Q} connecting the IQ mixer 12 which provides the baseband signal to the transimpedance amplifier TIA_{Q}.

The first mixer Mix_{I} is connected between the inputs I1 and I2 and the outputs O1_{I} and O2_{I}. The second mixer Mix_{Q} is connected between the inputs I1 and I2 and the outputs O1_{Q} and O2_{Q}. Hereafter, the IQ mixer 12 of FIG. 2, that only comprises the mixing stage 18, is called a resistive mixer.

The voltage V_{RF} corresponds to the RF voltage between nodes I1 and I2. The current I_{RF} is the RF current coming at node I1. From node I1, a current III goes to the mixer Mix_{I} and a current I_{INQ} goes to the mixer Mix_{Q}. The voltage V_{BBI} corresponds to the baseband voltage between the nodes O1_{I} and O2_{I}, and the voltage V_{BBQ} corresponds to the baseband voltage between the nodes O1_{Q} and O2_{Q}. The current I_{BBI} is the baseband current that circulates through node O1_{I} and the current I_{BBQ} is the baseband current that circulates through node O1_{Q}.

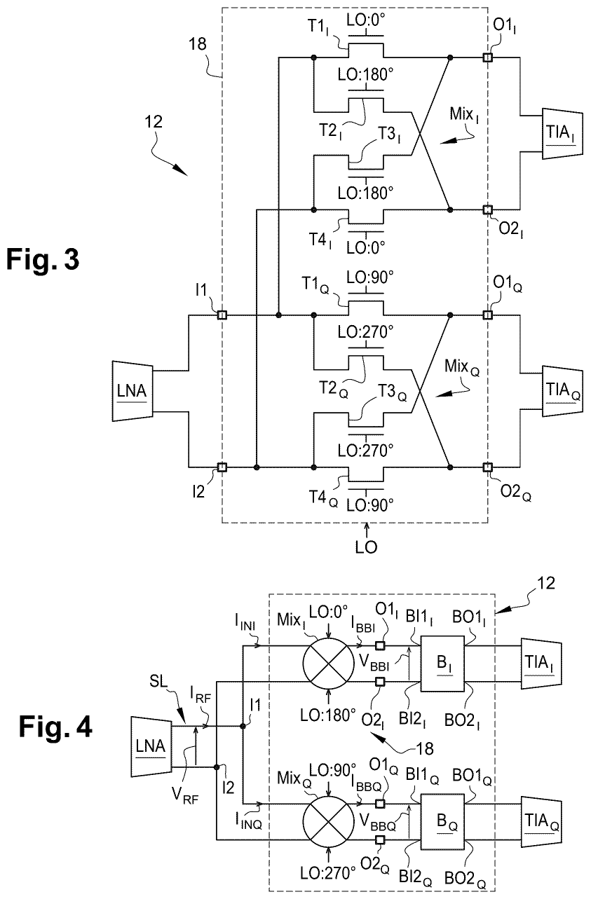

FIG. 3 is a block diagram similar to FIG. 2 illustrating an example of implementation of the direct conversion IQ mixer 12. In FIG. 3, the IQ mixer 12 is implemented with metal-oxide-semiconductor field-effect transistors, also called MOS transistors.

The first mixer Mix_{I} comprises: a first MOS transistor T1_{I}, for example N-channel, whose drain is coupled, preferably connected, to the node O1_{I}, whose source is coupled, preferably connected, to the node I1, and whose gate receives the oscillating signal LO: 0; a second MOS transistor T2_{I}, for example N-channel, whose drain is coupled, preferably connected, to the node O2_{I}, whose source is coupled, preferably connected, to the node I1, and whose gate receives the oscillating signal LO: 180; a third MOS transistor T3_{I}, for example N-channel, whose drain is coupled, preferably connected, to the node O1_{I}, whose source is coupled, preferably connected, to the node I2, and whose gate receives the oscillating signal LO: 180; and a fourth MOS transistor T4_{I}, for example N-channel, whose drain is coupled, preferably connected, to the node O2_{I}, whose source is coupled, preferably connected, to the node I2, and whose gate receives the oscillating signal LO: 0.

The second mixer Mix_{Q} comprises: a fifth MOS transistor T1_{Q}, for example N-channel, whose drain is coupled, preferably connected, to the node O1_{Q}, whose source is coupled, preferably connected, to the node I1, and whose gate receives the oscillating signal LO: 90; a sixth MOS transistor T2_{Q}, for example N-channel, whose drain is coupled, preferably connected, to the node O2_{Q}, whose source is coupled, preferably connected, to the node I1, and whose gate receives the oscillating signal LO: 270; a seventh MOS transistor T3_{Q}, for example N-channel, whose drain is coupled, preferably connected, to the node O1_{Q}, whose source is coupled, preferably connected, to the node I2, and whose gate receives the oscillating signal LO: 270; and an eighth MOS transistor T4_{Q}, for example N-channel, whose drain is coupled, preferably connected, to the node O2_{Q}, whose source is coupled, preferably connected, to the node I2, and whose gate receives the oscillating signal LO: 90.

According to one embodiment, the MOS transistors T1_{I}, T2_{I}, T3_{I}, T4_{I}, T1_{Q}, T2_{Q}, T3_{Q}, and T4_{Q} are identical.

FIG. 4 is a block diagram of an embodiment of the IQ mixer 12 of FIG. 2.

The IQ mixer 12 shown in FIG. 4 comprises the mixing stage 18 of the IQ mixer 12 shown in FIG. 2 and further comprises a first inductive block B_{I} and a second inductive block B_{Q}. The first inductive block B_{I} for baseband signal processing is located between the first mixer Mix_{I} of the mixing stage 18 and the first transimpedance amplifier TIA_{I}, and the second inductive block B_{Q} for baseband signal processing is located between the second mixer Mix_{Q} of the mixing stage 18 and the second transimpedance amplifier TIA_{Q}.

According to an embodiment, the first inductive block B_{I} corresponds to a first quadripole and the second inductive block B_{Q} corresponds to a second quadripole. The first quadripole B_{I} has a first input BILI coupled, preferably connected, to the output O1_{I} of the first mixer Mix_{I}, a second input BI2_{I} coupled, preferably connected, to output O2_{I} of the first mixer Mix_{I}, a first output BO₁ and a second output BO2_{I}. The second quadripole B_{Q} has a first input BI1_{Q} coupled, preferably connected, to output O1_{Q} of the second mixer Mix_{Q}, a second input BI2_{Q} coupled, preferably connected, to output O2_{Q} of the second mixer Mix_{Q}, a first output BO1_{Q} and a second output BO2_{Q}. The first output BO₁; and the second output BO2_{I} of the first inductive block B_{I} are coupled, preferably connected, to the first transimpedance amplifier TIA_{I}. The first output BO1_{Q} and the second output BO2_{Q} of the second inductive block B_{Q} are coupled, preferably connected, to the second transimpedance amplifier TIA_{Q}.

The first quadripole B_{I} and the second quadripole B_{Q} comprises an inductive component, preferably at least an inductor. According to an embodiment, the inductance of the first quadripole B_{I} is equal to the inductance of the second quadripole B_{Q} and is called L_{BB}. Hereafter, the direct conversion IQ mixer 12 of FIG. 4 is called inductive mixer.

Let us call impedance ZLNA the impedance seen by the IQ mixer 12 from inputs I1 and I2, impedance Z_{BBI} the impedance seen by the mixing stage 18 from the outputs O1_{I} and O21, and impedance Z_{BBQ} the impedance seen by the mixing stage 18 from the outputs O1_{Q} and O2_{Q}. The current I_{BBI}(t) is the baseband current crossing impedance Z_{BBI} and the current I_{BBQ}(t) is the baseband current crossing impedance Z_{BBQ}. Hereafter, to simplify the explanation, impedances Z_{BBI} and Z_{BBQ} are supposed to be the same and equal to impedance Z_{BB}.

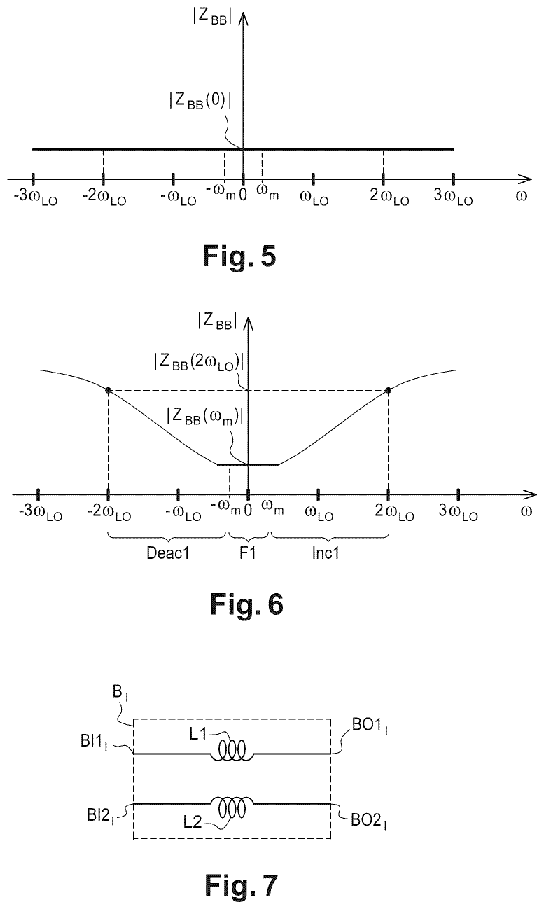

FIG. 5 is an amplitude spectrum of the impedance Z_{BB} when it is purely resistive. The amplitude of the impedance Z_{BB} is constant and equal to |Z_{BB}(0)|.

FIG. 6 is an amplitude spectrum of the impedance Z_{BB} for the IQ mixer 12 shown in FIG. 4. The amplitude spectrum comprises: a substantially flat portion F1 at least for the angular frequencies in the range from −ωₘ to ωₘ; a globally decreasing portion Deac1 at least for the angular frequencies in the range from −2ω_{LO} to −ωm, so that the module |Z_{BB}(−2ω_{LO})| of the impedance Z_{BB} at the angular frequency of −2ω_{LO} is at least ten times superior to the module |Z_{BB}(ωₘ)| of the impedance Z_{BB} at the angular frequency of ωₘ; and a globally increasing portion Inc1 for the angular frequencies in the range from Om to 2ω_{LO} so that the module |Z_{BB}(2ω_{LO})| of the impedance Z_{BB} at the angular frequency of 2ω_{LO} is at least ten times superior to the module |Z_{BB}(ωₘ)| of the impedance Z_{BB} at the angular frequency of ωₘ.

In this configuration, the conversion gain CG of the inductive mixer is superior to the conversion gain of the resistive mixer.

FIG. 7 is a block diagram of an embodiment of the inductive block B_{I} of the IQ mixer of FIG. 4. The inductive block B_{Q} can have the same structure as the inductive block B_{I}.

The inductive block B_{I} comprises a first inductor L1 having a first terminal coupled, preferably connected, to the first input I1_{I} and a second terminal coupled, preferably connected, to the first output O1_{I}. The inductive blocks B_{I} comprises a second inductor L2 having a first terminal coupled, preferably connected, to the second input I2_{I} and a second terminal coupled, preferably connected, to the second output O2_{I}. According to an embodiment, the first inductor L1 and the second inductor L2 have the same inductance equal to L_{BB}/2.

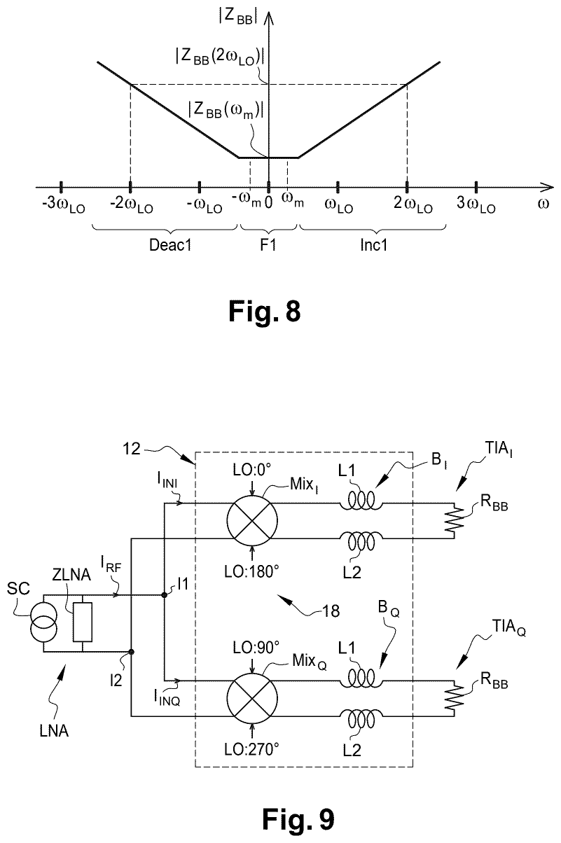

FIG. 8 shows an amplitude spectrum of the impedance Z_{BB} seen by the mixing stage 18 of the IQ mixer 12 of FIG. 4 with the inductive blocks B_{I} and B_{Q} having each the structure shown in FIG. 7.

The amplitude spectrum has a high-pass filter characteristic and comprises: a decreasing portion Deac1 for the angular frequencies inferior to −ωₘ, so that the module |Z_{BB}(−2ω_{LO})| of the impedance Z_{BB} at the angular frequency of −2ω_{LO} is at least ten times superior to the module |Z_{BB}(ωₘ)| of the impedance Z_{BB} at the angular frequency of ωₘ; a substantially flat portion F1 at least for the angular frequencies in the range from −ωₘ to ωₘ; and an increasing portion Inc1 for the angular frequencies superior to ωₘ, so that the module |Z_{BB}(2ω_{LO})| of the impedance Z_{BB} at the angular frequency of 2ω_{LO} is at least ten times superior to the module |Z_{BB}(ωₘ)| of the impedance Z_{BB} at the angular frequency of ωₘ.

Simulations have been made with the IQ mixer 12 having the structure shown in FIG. 4 with the inductive blocks B_{I} and B_{Q} having each the structure shown in FIG. 7. For the simulations, the angular frequency ω_{LO} is equal to 2*π*5*10⁹ rad/s and the angular frequency ωₘ is equal to 2*π*10⁶ rad/s.

FIG. 9 is a block diagram of the receiver of FIG. 1 with the IQ mixer of FIG. 4 with the inductive blocks Brand B_{Q} having each the structure shown in FIG. 7 showing the parameters used for simulations. In FIG. 9, each inductor L1 and L2 has an inductance equal to L_{BB}/2.

The low noise amplifier LNA is simulated by a current source SC, sourcing an RF current I_{RF} at the angular frequency ω_{LO}+ωₘ, and impedance ZLNA coupled in parallel between the inputs I1 and I2 of the IQ mixer 12. Each low impedance transimpedance amplifier TIA_{I} and TIA_{Q} is simulated by a resistor R_{BB}. For the simulations, the mixing stage 18 is considered with a duty cycle equal to 50%. The mixer switch on resistance is equal to zero Ohm.

The conversion gain CG of the IQ mixer 12 is calculated taking the ratio of the harmonic power of the baseband current I_{BBI} (supposed equal to I_{BBQ}) at the angular frequency ωₘ over the harmonic power of the RF current I_{RF} at the angular frequency ω_{LO}+ωₘ.

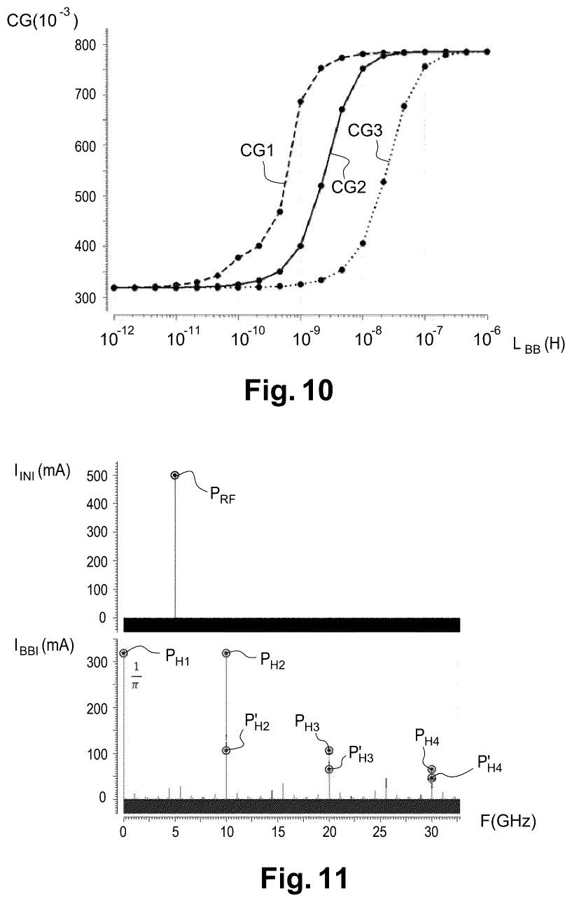

FIG. 10 shows curves CG1, CG2, CG3 of evolution of the conversion gain CG of the IQ mixer 12 of FIG. 4, with the inductive blocks B_{I} and B_{Q} having each the structure shown in FIG. 7, with respect to the inductance L_{BB} for three values of resistances R_{BB}. Curve CG1 is obtained with R_{BB} equal to 10 ohms, curve CG2 is obtained with R_{BB} equal to 100 ohms, and curve CG3 is obtained with R_{BB} equal to 1 kiloohms. For low values of the inductance L_{BB}, the conversion gain CG is substantially equal to the conversion gain CG obtained for the resistive mixer 12 shown in FIG. 2, that is without the inductive blocks Brand B_{Q}, and tends to the value 1/π, that is 0.318. For large values of the inductance L_{BB}, the conversion gain CG tends to the value \sqrt{2/π}, that is 0.798, regardless of the resistance value R_{BB}. The conversion gain CG for the inductive mixer 12 with the mixers M_{I} and M_{Q} having the structure shown in FIG. 7 is therefore advantageously superior to the conversion gain for the resistive mixer.

FIG. 11 shows, in the upper part, the spectrum of the current I_{INI} supplying the resistive mixer of FIG. 2 and shows, in the lower part, the spectrum of the current I_{BBI} supplied by the resistive mixer of FIG. 2.

For the resistive mixer, the spectrum of the current I_{INI} has a single peak PRF at the frequency of 5.001 GHz, that corresponds to the angular frequency of ω_{LO}+ωₘ. For the resistive mixer, the spectrum of the current I_{BBI} has a peak P_{H1} at the frequency of 1 MHz, that corresponds to the angular frequency of ωₘ, having an amplitude equal to 1/π, and has peaks P′_{H2}, P_{H2}, P′_{H3}, P′₃, P′_{H4}, and P_{H4} respectively at frequencies of 9.999 GHz, 10.001 GHz, 19.999 GHz, 20.001 GHz, 29.999 GHz, 30.001 GHz, that correspond respectively to the angular frequencies of 2ω_{LO}−ωₘ, 2ω_{LO}+ωₘ, 3ω_{LO}−ωₘ, 3ω_{LO}+ωₘ, 4ω_{LO}−ωₘ, and 4ω_{LO}+ωₘ, each having an amplitude different from zero.

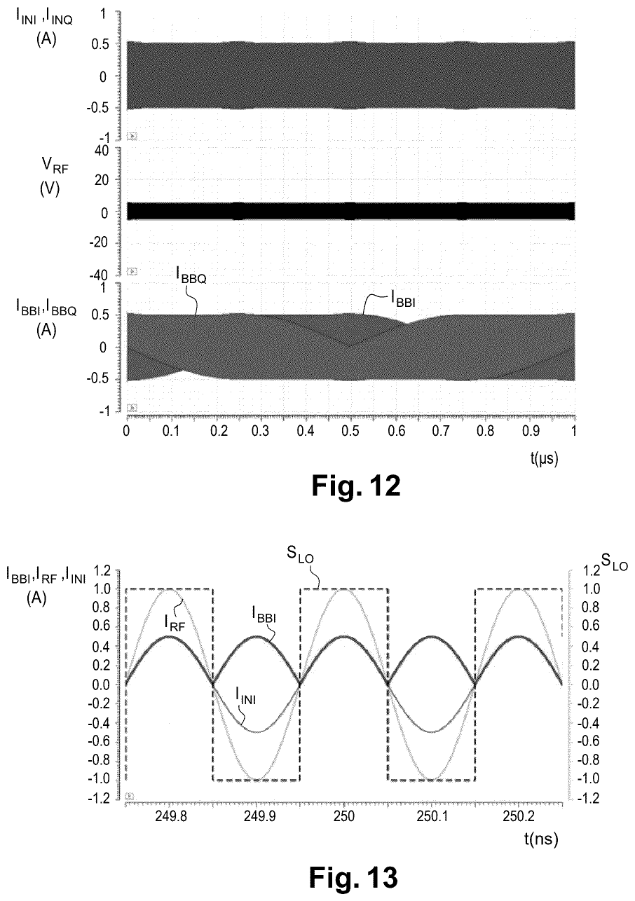

FIG. 12 shows, for the resistive mixer of FIG. 2, chronograms of the current I_{INI} and I_{INQ} supplying the resistive mixer, the voltage V_{RF} between the nodes I1 and I2 and the currents I_{BBI} and I_{BBQ} supplied the resistive mixer.

FIG. 13 shows chronograms, at a smaller time scale than FIG. 12, of the currents I_{RF}, I_{INI} and I_{BBI} and the command signal S_{LO} for the resistive mixer of FIG. 2. As it appears in FIG. 13, the current I_{INI} is substantially equal to half the current I_{RF}.

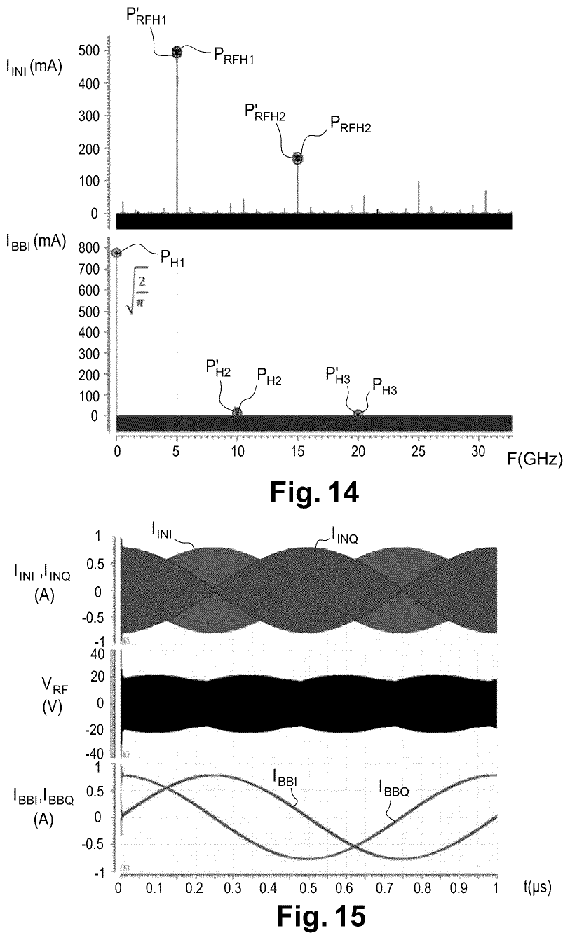

FIG. 14 shows, in the upper part, the spectrum of the current INI supplying the IQ mixer of FIG. 4 with the inductive blocks Brand B_{Q} having each the structure shown in FIG. 7 and shows, in the lower part, the spectrum of the current I_{BBI} supplied by the IQ mixer of FIG. 4 with the inductive blocks B_{I} and B_{Q} having each the structure shown in FIG. 7.

For the inductive mixer, the spectrum of the current I_{INI} has a peak P′_{RFH1} at the frequency of 4.999 GHz, that corresponds to the angular frequency of ω_{LO}−ωₘ, a peak P_{RFH1} at the frequency of 5.001 GHz, that corresponds to the angular frequency of ω_{LO}+ωₘ, a peak P′_{RFH2} at the frequency of 14.999 GHz, that corresponds to the angular frequency of 2010-Om, a peak P_{RFH2} at the frequency of 15.001 GHz, that corresponds to the angular frequency of 2ω_{LO}+ωₘ. For the inductive mixer, the spectrum of the current I_{BBI} has a peak P_{H1} at the frequency of 1 MHz, that corresponds to the angular frequency of ωₘ, having an amplitude equal to 2/π, and has peaks P′_{H2}, P_{H2}, P′_{H3}, P_{H3}, respectively at frequencies of 9.999 GHz, 10.001 GHz, 19.999 GHz, 20.001 GHz, that correspond respectively to the angular frequencies of 2ω_{LO}−ωₘ, 2ω_{LO}+ωₘ, 3ω_{LO}−ωₘ, 3ω_{LO}+ωₘ, each having an amplitude substantially equal to zero.

FIG. 15 shows, for the inductive mixer of FIG. 4 with the inductive blocks B_{I} and B_{Q} having each the structure shown in FIG. 7, chronograms of the current I_{INI} and I_{INQ} supplying the inductive mixer, the voltage V_{RF} between the nodes I1 and I2 and the currents I_{BBI} and I_{BBQ} supplied by the inductive mixer. As it appears in FIG. 15, the currents I_{BBI} and I_{BBQ} have each a sinusoidal shape.

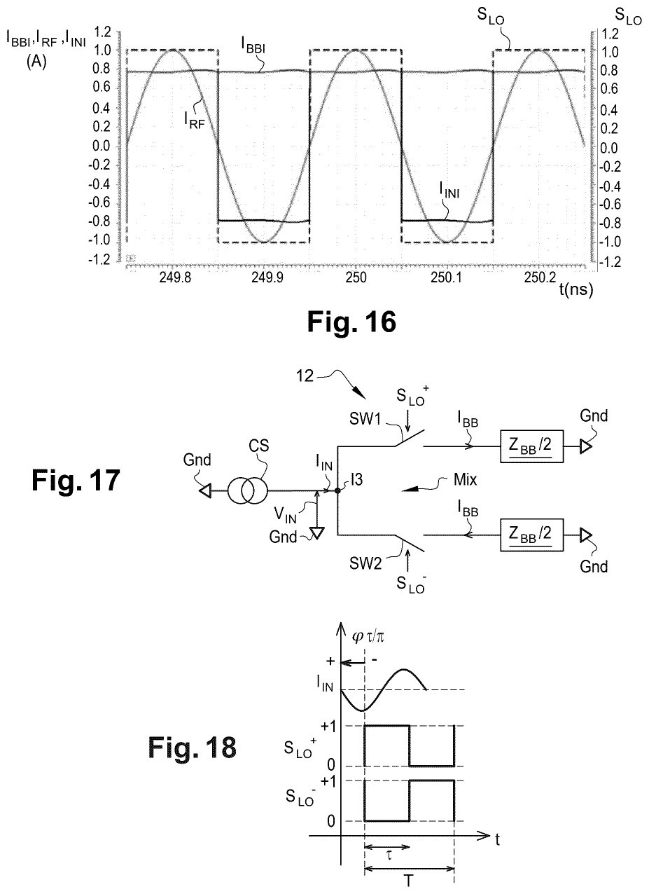

FIG. 16 shows chronograms, at a smaller time scale than FIG. 15 the currents I_{RF}, I_{INI} and I_{BBI} and the command signal S_{LO} for the inductive mixer. As it appears in FIG. 16, the current I_{INI} is not equal to half the current I_{RF}.

The down-converted current spectrum for the inductive mixer has negligible power in all the harmonics other than the wanted signal at the angular frequency of ωₘ or, in other words, all the input radiofrequency mixer power is down-converted in the power of one harmonic at the angular frequency of ωₘ.

FIG. 17 shows a model for a mixer Mix, which corresponds to the mixer Mix_{I} or the mixer Mix_{Q} of the IQ mixer 12, used to explain the increase of the conversion gain of the inductive mixer with respect to the conversion gain of the resistive mixer and FIG. 18 shows chronograms of signals during the operation of the mixer Mix.

The model comprises a current source CS, providing the current I_{IN}, which corresponds to the current I_{INI} or the current I_{INQ}, to a node I3, the current source CS having a first terminal connected to the node I3 and a second terminal connected to the low potential reference source Gnd, for example the ground. The voltage at the node I3 is called V_{IN}. The mixer Mix is modeled by a first switch SW1 controlled by a command signal S_{LO}⁺ and by a second switch SW2 controlled by a command signal S_{LO}⁻. The first switch SW1 has a first terminal connected to the node I3. The second switch SW2 has a first terminal connected to the node I3. The inductive block B_{I} or B_{Q} and the transimpedance amplifier TIA_{I} or TIA_{Q} are modeled by a first impedance Z_{BB}/2 having a first terminal connected to a second terminal of the first switch SW1 and a second terminal connected to the low potential reference source Gnd, and a second impedance Z_{BB}/2 having a first terminal connected to a second terminal of the second switch SW2 and a second terminal connected to the low potential reference source Gnd. Each impedance Z_{BB}/2 is crossed by a current I_{BB}, which corresponds to the current I_{BBI} or the current I_{BBQ}. The voltage V_{BB}, which corresponds to the voltage V_{BBI} or the voltage V_{BBQ}, is the voltage across the two impedances Z_{BB}/2.

The command signals S_{LO}⁺ and S_{LO}⁻ are square signals each having a period T. The command signal S_{LO}⁻ is shifted from 180° with respect to the command signal S_{LO}⁺. The command signal S_{LO}⁺ corresponds to the oscillating signal LO: 0 or to the oscillating signal LO: 90 previously described when the mixer Mix models the mixer Mix_{I} and the command signal S_{LO}⁻ corresponds to the oscillating signal LO: 180 or to the oscillating signal LO: 270 previously described when the mixer Mix models the mixer Mix_{Q}. Each command signal S_{LO}⁺ and S_{LO}⁻ alternates between the value 1 and the value 0. For example, when the command signal S_{LO}⁺ (respectively S_{LO}⁻) is equal to 1, the switch SW1 (respectively SW2) is closed and when the command signal S_{LO}⁺ (respectively S_{LO}⁻) is equal to 0, the switch SW1 (respectively SW2) is open. The duty cycle of the command signals S_{LO}⁺ and S_{LO}⁻ is equal to τ/T. When the duty cycle is equal to 0.5, this means that T is equal to 2τ. The current I_{IN} is phase shifted by φ with respect to the command signal S_{LO}⁺, which corresponds to a time shift of φτ/π when T is equal to 2τ. For the mixer Mix_{I}, the phase shift φ is equal to 0, and, for the mixer Mix_{Q}, the phase shift φ is equal to −π/2. In the following description, unless indicated otherwise, the command signal S_{LO} designates either the command signal S_{LO}⁺ or the command signal S_{LO}⁻.

Let us suppose that the current I_{IN}(t) received by the mixer Mix at the node I3 is defined by the following equation:

$${I}_{IN} ( t ) = {I}_{M R F} cos [ ( {ω}_{LO} + {ω}_{m} ) t ] \qquad ( Eq . 1 )$$

where I_{MRF} is the maximum intensity of the current I_{IN}(t), where ω_{LO} is the angular frequency of the oscillating signal S_{LO}, that is equal to 2π/T, and where ωₘ is the angular frequency of the useful signal.

In the frequency domain, the current I_{IN}(ω) received by the mixer Mix at the node I3 is defined by the following equation:

$${I}_{IN} ( ω ) = \frac{{I}_{MRF}}{2} [ δ ( ω - ( {ω}_{L O} + {ω}_{m} ) ) {e}^{j 0} + δ ( ω + ( {ω}_{L O} + {ω}_{m} ) ) {e}^{- j 0} ] \qquad ( Eq . 2 )$$

The command signal S_{LO}(t) is equal to the convolution of a rectangular signal and a Dirac comb. In the frequency domain, the command signal S_{LO}(ω) is defined by the following equation:

$${S}_{L O} ( ω ) = \frac{1}{2} sinc ( \frac{π}{2} \frac{ω}{{ω}_{LO}} ) {\sum }_{n = - ∞}^{+ ∞} [ δ ( ω - n {ω}_{LO} ) {e}^{- j \frac{ω}{n {ω}_{LO}} φ} ] \qquad ( Eq . 3 )$$

The current I_{BB}(t) provided by the mixer Mix is equal to the product of the current I_{IN}(t) and the command signal S_{LO}(t). This means that, in the frequency domain, the current I_{BB}(ω) is equal to the convolution of the current I_{IN}(ω) and the command signal S_{LO}(ω) and is defined by the following equation:

$${I}_{B B} ( ω ) = \frac{{I}_{MRF}}{4} {\sum }_{n = - ∞}^{+ ∞} sinc ( \frac{n π}{2} ) [ δ ( ω + ( n - 1 ) {ω}_{LO} - {ω}_{m} ) {e}^{j φ} + δ ( ω + ( n + 1 ) {ω}_{LO} + {ω}_{m} ) {e}^{- j φ} ] \qquad ( Eq . 4 )$$

If we consider only the terms for n equal to −1, and 1 and if we consider that ωₘ is greatly inferior to ω_{LO}, the previous equation becomes the following equation:

$${I}_{B B} ( ω ) = \frac{{I}_{M R F}}{2 π} [ {e}^{j φ} δ ( ω - {ω}_{m} ) + {e}^{- j φ} δ ( ω + {ω}_{m} ) ] + \frac{{I}_{MRF}}{2 π} [ {e}^{j φ} δ ( ω - 2 {ω}_{LO} - {ω}_{m} ) + {e}^{- j φ} δ ( ω + 2 {ω}_{LO} + {ω}_{m} ) ] \qquad ( Eq . 5 )$$

which corresponds in the time domain to the following equation:

$${I}_{BB} ( t ) = \frac{{I}_{M R F}}{π} cos ( {ω}_{m} t + φ ) + \frac{{I}_{M R F}}{π} cos ( ( 2 {ω}_{LO} + {ω}_{m} ) t + φ ) \qquad ( Eq . 6 )$$

The conversion gain CG is given by the following equation:

$$CG = \frac{abs ( {I}_{B B} ( {ω}_{m} ) )}{abs ( {I}_{IN} ( {ω}_{LO} + {ω}_{m} ) )} = \frac{1}{π} \qquad ( Eq . 7 )$$

This value corresponds to the conversion gain CG that is obtained by simulation for a resistive mixer.

Another approach is to use the equation (Eq. 6) above for the current I_{BB}(t) to determine the conversion gain CG by a different way.

The voltage V_{BB}(t) is equal to the convolution of the current I_{BB}(t) and the impedance Z_{BB}(t). Therefore, in the frequency domain, the voltage V_{BB}(ω) is given by the following equation:

$${V}_{B B} ( ω ) = \frac{{I}_{MRF}}{4} {\sum }_{n = - ∞}^{+ ∞} sinc ( \frac{n π}{2} ) [ {e}^{j φ} δ ( ω + ( n - 1 ) {ω}_{LO} - {ω}_{m} ) {Z}_{B B} ( ( n - 1 ) {ω}_{LO} - {ω}_{m} ) + {e}^{- j φ} δ ( ω + ( n + 1 ) {ω}_{LO} + {ω}_{m} ) {Z}_{B B} ( ( n + 1 ) {ω}_{LO} + {ω}_{m} ) ] \qquad ( Eq . 8 )$$

The voltage V_{IN}(t) is equal to the product of the voltage V_{BB}(t) and the command signal S_{LO}(t). Therefore, in the frequency domain, the voltage V_{IN}(ω) is equal to the convolution of the voltage V_{BB}(ω) and the command signal S_{LO}(ω).

If we consider that Om is greatly inferior to ω_{LO}, the voltage V_{IN}(ω_{LO}+ωₘ) is given by the following relation:

$${V}_{IN} ( {ω}_{LO} - {ω}_{m} ) = \frac{1}{4} ( {\sum }_{n \neq 0 , - 1}^{{+ ∞}_{n = - ∞}} [ {sinc}^{2} ( \frac{n π}{2} ) {Z}_{B B} ( ( n + 1 ) {ω}_{L O} ) ] + {\sum }_{n \neq 0 , - 1}^{{+ ∞}_{n = - ∞}} [ {sinc}^{2} ( \frac{n π}{2} ) {Z}_{B B} ( ( n - 1 ) {ω}_{L O} ) ] + 2 {sinc}^{2} ( \frac{π}{2} ) {Z}_{B B} ( {ω}_{m} ) ) {I}_{RF} {e}^{j φ} \qquad ( Eq . 9 )$$

and the voltage V_{IN}(ω_{LO}−ωₘ) is given by the following relation:

$${V}_{IN} ( {ω}_{LO} - {ω}_{m} ) = \frac{1}{4} ( {\sum }_{n \neq 0 , - 1}^{{+ ∞}_{n = - ∞}} [ sin {c}^{2} ( \frac{n π}{2} ) {Z}_{BB} ( ( n + 1 ) {ω}_{LO} ) ] + {\sum }_{n \neq 0 , 1}^{{+ ∞}_{n = - ∞}} [ sin {c}^{2} ( \frac{n π}{2} ) {Z}_{BB} ( ( n - 1 ) {ω}_{LO} ) ] + 2 sin {c}^{2} ( \frac{π}{2} ) {Z}_{BB}^{*} ( {ω}_{m} ) ) {I}_{RF} {e}^{j φ} \qquad ( Eq . 10 )$$

When the impedance Z_{BB} is purely resistive, the equations (Eq. 9) and (Eq. 10) above can be simplified into the following equation:

$${V}_{IN} ( {ω}_{LO} \pm {ω}_{m} ) = \frac{1}{4} [ ( 1 - \frac{4}{{π}^{2}} ) + ( 1 - \frac{4}{{π}^{2}} ) + 2 \frac{4}{{π}^{2}} ] {R}_{BB} {I}_{MRF} {e}^{j φ} = \frac{{R}_{BB}}{2} {I}_{MRF} {e}^{j φ} \qquad ( Eq . 11 )$$

If we consider only the terms for n equal to −1, the equation (Eq. 11) above becomes the following equations:

$${V}_{IN} ( {ω}_{LO} + ω ) = \frac{2}{{π}^{2}} {Z}_{BB} ( {ω}_{m} ) {I}_{MRF} {e}^{j φ} {V}_{IN} ( {ω}_{LO} - {ω}_{m} ) = \frac{2}{{π}^{2}} {Z}_{BB}^{*} ( {ω}_{m} ) {I}_{MRF} {e}^{j φ} \qquad ( Eq . 12 )$$

The input radiofrequency mixer impedance Z_{RF}(ω_{LO}+ωₘ) at ω_{LO}+ωₘ, with a mixer baseband load equal to Z_{BB}(ω), is calculated to be:

$${Z}_{R F} ( {ω}_{LO} + {ω}_{m} ) = \frac{1}{2} ( {\sum }_{n \neq 0 , - 1}^{{+ ∞}_{n = - ∞}} [ sin {c}^{2} ( \frac{n π}{2} ) {Z}_{BB} ( ( n + 1 ) {ω}_{LO} ) ] + {\sum }_{n \neq 0 , 1}^{{+ ∞}_{n = - ∞}} [ sin {c}^{2} ( \frac{n π}{2} ) {Z}_{BB} ( ( n - 1 ) {ω}_{LO} ) ] + 2 sin {c}^{2} ( \frac{π}{2} ) {Z}_{BB} ( {ω}_{m} ) ) \qquad ( Eq . 13 )$$

The input radiofrequency IQ mixer real part R_{RF}(ω_{LO}+ωₘ) of the impedance at ω_{LO}+ωₘ with a resistive load is defined by the following equation:

$${R}_{RF} ( {ω}_{LO} + {ω}_{m} ) = \frac{1}{2} ( [ 0.5 - \frac{4}{{π}^{2}} ] + [ 0.5 - \frac{4}{{π}^{2}} ] + 2 \frac{4}{{π}^{2}} ) {R}_{BB} = \frac{{R}_{BB}}{2} \qquad ( Eq . 14 )$$

The input RF IQ mixer efficiency Eff is defined by the following equation:

$$Eff = \frac{{P}_{outIQ © ω m}}{{P}_{in}} = \frac{2 {( C {G}_{RBB} )}^{2} {( {I}_{MRF} )}^{2} {R}_{BB} ( {ω}_{m} )}{{( {I}_{MRF} )}^{2} {R}_{R F RBB} ( {ω}_{LO} + {ω}_{m} )} \qquad ( Eq . 15 )$$

The efficiency Eff is equal to 1 when the power at ωₘ supplied by the IQ mixer 12 is equal to the input RF power.

For the resistive mixer, the equation (Eq. 15) above becomes the following equation:

$$Eff = \frac{2 {( \frac{1}{π} )}^{2}}{\frac{1}{2}} = \frac{4}{{π}^{2}} \qquad ( Eq . 16 )$$

The input radiofrequency IQ mixer real part R_{RF} of the impedance Z_{RF} at ω_{LO}+ωₘ for the inductive mixer, that is to say with an inductive load Z_{BB}(ω) equal to R_{BB}+jωL_{BB}, in the limit condition where the impedance |Z_{BB}(NOLO)| at the angular frequency of nω_{LO} is greatly superior to the module of the impedance |Z_{BB}(ωₘ)| for any n, n being an integer superior to 1, is calculated to be:

$${R}_{RF} ( {ω}_{LO} + {ω}_{m} ) = sin c ( \frac{π}{2} ) {Z}_{BB} ( {ω}_{m} ) = \frac{4}{π} {R}_{BB} \qquad ( Eq . 17 )$$

For the inductive mixer, the input radiofrequency IQ mixer efficiency Eff is defined by the following equation:

$$Eff = \frac{{P}_{outIQ ©ω m}}{{P}_{in}} = \frac{2 {( {CG}_{LBB} )}^{2} {( {I}_{MRF} )}^{2} {R}_{BB}}{{( {I}_{RF} )}^{2} {R}_{RF} ( {ω}_{LO} + {ω}_{m} )} = \frac{2 {( C {G}_{LBB} )}^{2}}{\frac{4}{π}} \qquad ( Eq . 18 )$$

An efficiency Eff equals to 1 corresponds to a conversion gain CG equal to \sqrt{2/π}, which is the value given by the simulations.

When the impedance Z_{BB}(ω) is purely resistive, the current I_{INI}(t) is equal to I_{RF}(t)/2. When the impedance Z_{BB}(ω) comprises an inductive component L_{BB}, the current I_{INI}(t) comprises a component I_{HI}(t) that comes directly from the current I_{RF}(t) and a component I_{LI}(t) that comes from the mixer Mix_{Q} and the current I_{INQ}(t) comprises a component I_{HQ}(t) that comes directly from the current I_{RF}(t) and a component I_{LQ}(t) that comes from the mixer Mix_{I}.

The current IH_{I}(t) is given by the following equation:

$${IH}_{I} ( t ) = cos [ ( {ω}_{LO} + {ω}_{m} ) t ] \qquad ( Eq . 19 )$$

In the frequency domain, the current IH_{I}(ω) is given by the following equation:

$${IH}_{I} ( ω ) = \frac{1}{2} [ δ ( ω - ( {ω}_{LO} + {ω}_{m} ) ) + δ ( ω + ( {ω}_{LO} + {ω}_{m} ) ) ] \qquad ( Eq . 20 )$$

The current I_{LI}(t) is given by the following equation:

$${IL}_{I} ( t ) = A sing ( cos [ ( {ω}_{LO} - {ω}_{m} ) t ] ) - B cos [ ( {ω}_{LO} - {ω}_{m} ) t ] \qquad ( Eq . 21 )$$

where A and B are constants, and where sign(x) is equal to 1 when x is superior or equal to 0 and sign(x) is equal to −1 when x is inferior to 0.

In the frequency domain, the current I_{LI}(ω) is given by the following equation:

$${IL}_{I} ( ω ) = \frac{A π}{{ω}_{LO}} sin c ( \frac{π}{2} \frac{( {ω}_{LO} - {ω}_{m} )}{{ω}_{LO}} ) - \frac{B}{2} [ δ ( ω - ( {ω}_{LO} - {ω}_{m} ) ) + δ ( ω + ( {ω}_{LO} - {ω}_{m} ) ) ] \qquad ( Eq . 22 )$$

The relation between the current INI (t) and the currents IH_{I}(t) and I_{LI}(t) is given by the following equation:

$$\frac{{I}_{INI}}{2} ( t ) = {IH}_{I} ( t ) + {IL}_{I} ( t ) \qquad ( Eq . 23 )$$

There is an optimal choice for constants A and B that maximizes the ratio I_{BB}(ωₘ)/I_{BB}(2nω_{LO}+ωₘ) with an upper bound for constant A set by the condition of the efficiency Eff equal to 1.

With this choice for the constants A and B, the current I_{BBI}(t) is well represented by the following equation:

$${I}_{BB} ( t ) = {S}_{LO} ( t ) ( {IH}_{I} ( t ) + {IL}_{I} ( t ) ) = cos [ {ω}_{m} t ] \qquad ( Eq . 24 )$$

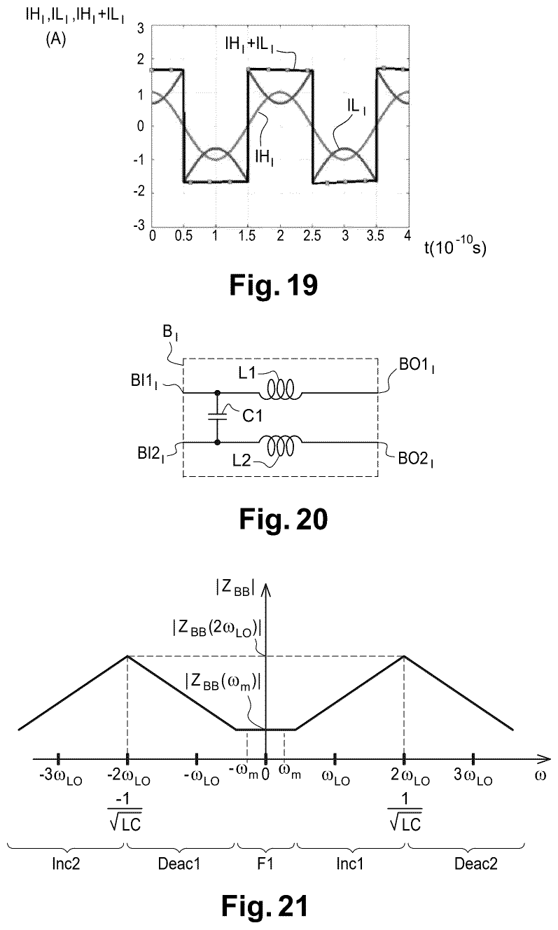

FIG. 19 show chronograms of signals during the operation of the IQ mixer of FIG. 5. FIG. 19 shows that the current I_{INI}(t) is substantially equal to a square signal.

FIG. 20 is a block diagram of another embodiment of the inductive block B_{I} of the IQ mixer 12 of FIG. 4. The inductive block B_{Q} can have the same structure as the inductive block B_{I}.

The inductive block B_{I} shown in FIG. 20 comprises all the elements of the inductive block B_{I} shown in FIG. 7 and further comprises a capacitor C1 having a first terminal coupled, preferably connected, to the first input BILI and a second terminal coupled, preferably connected, to the second input BI2_{I}.

FIG. 21 shows an amplitude spectrum of the impedance Z_{BB} seen by the mixing stage 18 of the IQ mixer 12 of FIG. 4 with the inductive blocks B_{I} and B_{Q} having each the structure shown in FIG. 20.

The amplitude spectrum comprises: an increasing portion Inc2 for the angular frequencies inferior to −2ω_{LO}; a decreasing portion Deac1 for the angular frequencies in the range from −2ω_{LO} to −ωₘ, so that the module |Z_{BB}(−2ω_{LO})| of the impedance Z_{BB} at the angular frequency of −2ω_{LO} is at least ten times superior to the module |Z_{BB}(ωₘ)| of the impedance Z_{BB} at the angular frequency of ωₘ; a substantially flat portion F1 at least for the angular frequencies in the range from −ωₘ to ωₘ; an increasing portion Inc1 for the angular frequencies in the range from ωₘ to 2ω_{LO}, so that the module |Z_{BB}(2ω_{LO})| of the impedance Z_{BB} at the angular frequency of 2ω_{LO} is at least ten times superior to the module |Z_{BB}(ωₘ)| of the impedance at the angular frequency of ωₘ; and a decreasing portion Deac2 for the angular frequencies superior to 2ω_{LO}.

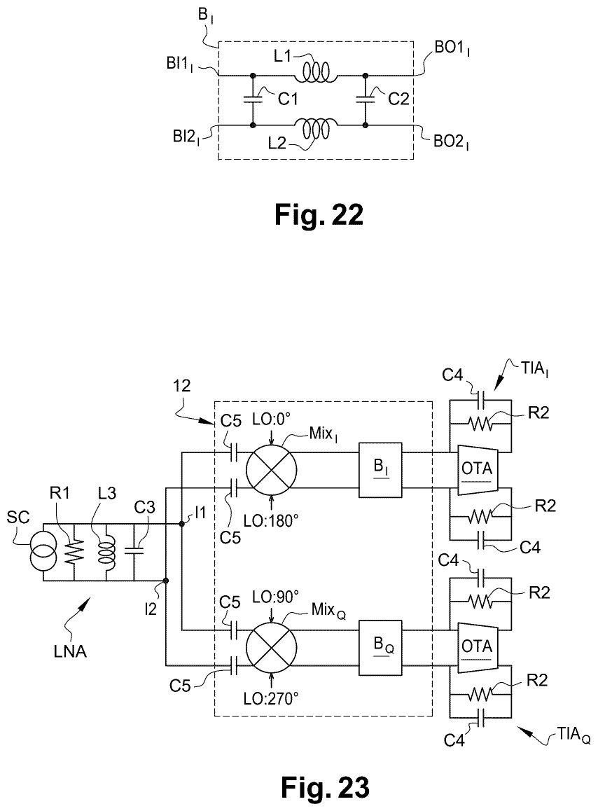

FIG. 22 is a block diagram of another embodiment of the inductive block B_{I} of the IQ mixer 12 of FIG. 4. The inductive block B_{Q} can have the same structure as the inductive block B_{I}.

The inductive block B_{I} shown in FIG. 22 comprises all the elements of the inductive block B_{I} shown in FIG. 20 and further comprises a capacitor C2 having a first terminal coupled, preferably connected, to the first output BO1_{I} and a second terminal coupled, preferably connected, to the second output BO2_{I}.

Simulations have been made with the IQ mixer having the structure shown in FIG. 4 with the inductive blocks Brand B_{Q} having each the structure shown in FIG. 22. For the simulations, for each inductive block Brand B_{Q}, the capacitor C1 has a capacitance equal to 70 fF, the capacitor C2 has a capacitance equal to 7 pF, the inductor L1 has an inductance L_{BB}/2 equal to 2 nH, and the inductor L1 has an inductance L_{BB}/2 equal to 2 nH.

FIG. 23 is a block diagram of the receiver of FIG. 1 with the IQ mixer of FIG. 4 with the inductive blocks B_{I} and B_{Q} having each the structure shown in FIG. 22 showing the parameters used for simulations.

The low noise amplifier LNA is simulated by a current source SC, an inductor L3, a capacitor C3, and a resistor R1 coupled in parallel between the inputs I1 and I2 of the IQ mixer. For the simulations, the inductor L3 has an inductance of 2 nH, the capacitor C3 has a capacitance of 500 fF, and the resistor R1 has a resistance of 1 kΩ. Each transimpedance amplifier TIA_{I} and TIA_{Q} is simulated by an ideal differential operational transconductance amplifier OTA and a capacitor C4 and a resistor R2 coupled in parallel between the inputs and the outputs of the ideal differential operational transconductance amplifier OTA. For the simulations, the cutoff frequency of the transimpedance amplifier TIA_{I} and TIA_{Q} is equal to 40 MHz, the capacitor C4 has a capacitance of 250 fF, and the resistor R2 has a resistance of 16 kΩ. For the simulations, the mixing stage 18 is considered with a duty cycle equal to 50% and an on-state resistance equal to 50Ω. Moreover, a coupling capacitor C5 is provided for each mixer Mix_{I} and Mix_{Q} at each input I1 and I2. For the simulations, the capacitance of capacitor C5 is equal to 70 fF.

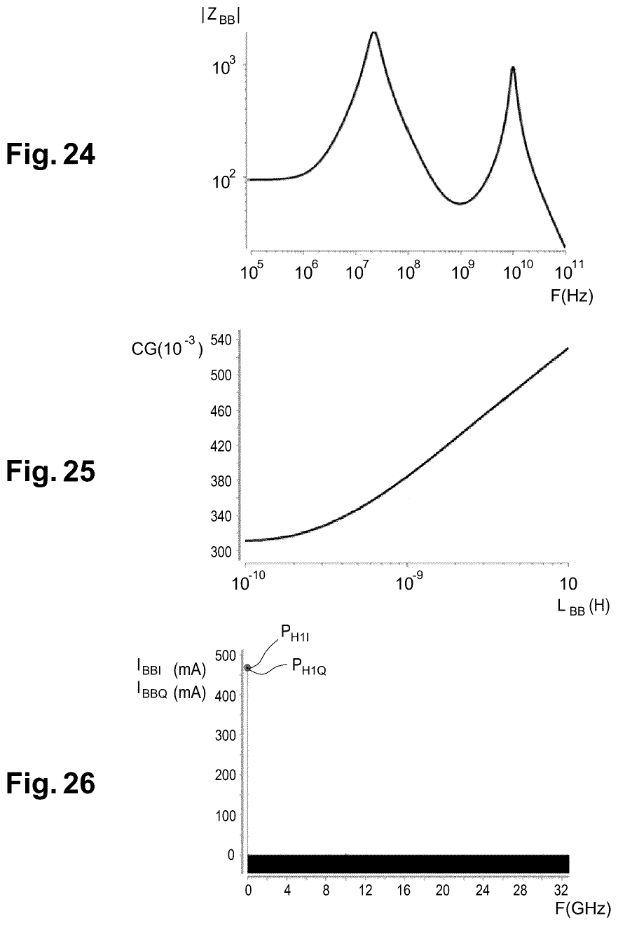

FIG. 24 shows an amplitude spectrum of the impedance Z_{BB} seen by the mixing stage 18 of the IQ mixer of FIG. 4 with the inductive blocks Brand B_{Q} having each the structure shown in FIG. 22.

FIG. 25 shows a curve of evolution of the conversion gain CG of the IQ mixer of FIG. 4, with the inductive blocks Brand B_{Q} having each the structure shown in FIG. 22, with respect to the inductance L_{BB} of the inductive blocks Brand B_{Q}. When the inductance L_{BB} becomes high, the conversion gain for the inductive mixer 12 with the mixers M_{I} and M_{Q} having the structure shown in FIG. 22 is advantageously superior to the conversion gain for the resistive mixer.

FIG. 26 shows the spectrum of the currents I_{BBI} and I_{BBQ} supplied by the IQ mixer of FIG. 4 with the inductive blocks B_{I} and B_{Q} having each the structure shown in FIG. 22 and with the inductance L_{BB} equal to 4 nH. The spectrum of the current I_{BBI} has a single peak P_{HI1} at the frequency of 1 MHz, that corresponds to the angular frequency of ωₘ, having an amplitude equal substantially to 0.777. The spectrum of the current I_{BBQ} also has a single peak P_{H1Q} at the frequency of 1 MHz, that corresponds to the angular frequency of ωₘ, having an amplitude equal substantially to 0.777.

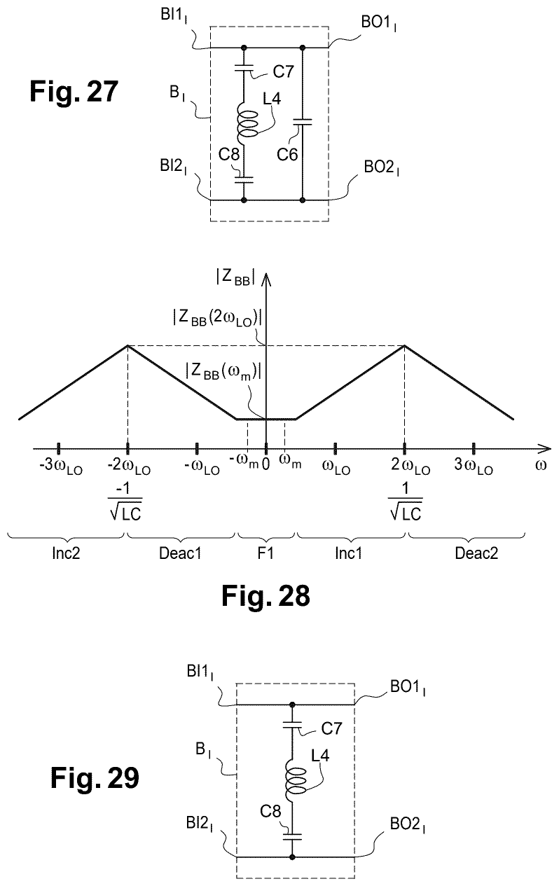

FIG. 27 is a block diagram of another embodiment of the inductive block B_{I} of the IQ mixer 18 of FIG. 4. The inductive block B_{Q} can have the same structure as the inductive block B_{I}.

In the inductive block B_{I} shown in FIG. 27, the first input BILI is connected to the first output BO1_{I} and the second input BI2_{I} is connected to the second output BO2_{I}. The inductive block B_{I} further comprises a capacitor C6 having a first terminal coupled, preferably connected, to the first input BILI and a second terminal coupled, preferably connected, to the second input BI2_{I}. The inductive block B_{I} further comprises, coupled in series between the first input BI1_{I} and the second input BI1_{Q}, a capacitor C7, an inductor LA, and a capacitor C8. The capacitor C7 has a first terminal coupled, preferably connected, to the first input BILI and a second terminal coupled, preferably connected, to a first terminal of the inductor L4. The capacitor C8 has a first terminal coupled, preferably connected, to the second input BI2_{I} and a second terminal coupled, preferably connected, to a second terminal of the inductor L4.

FIG. 28 shows an amplitude spectrum of the impedance Z_{BB} seen by the mixing stage 18 of the IQ mixer 12 of FIG. 4 with the inductive blocks B_{I} and B_{Q} having each the structure shown in FIG. 27. The amplitude spectrum shown in FIG. 28 is identical to the amplitude spectrum shown in FIG. 21.

FIG. 29 is a block diagram of another embodiment of the inductive block B_{I} of the IQ mixer 12 of FIG. 4. The inductive block B_{Q} can have the same structure as the inductive block B_{I}.

The inductive block B_{I} shown in FIG. 29 is identical to the inductive block B_{I} shown in FIG. 27, except that the capacitor C6 is not present. The inductive block B_{I} shown in FIG. 29 therefore comprises coupled in series between the first input BILI and the second input BI1_{Q}, the capacitor C7, the inductor LA, and the capacitor C8.

Simulations have been made with the IQ mixer having the structure shown in FIG. 4 with the inductive blocks B_{I} and B_{Q} having each the structure shown in FIG. 29. For the simulations, for each inductive block B_{I} and B_{Q}, the capacitor C7 has a capacitance equal to 2 pF, the capacitor C8 has a capacitance equal to 2 pF, and the inductor LA has an inductance L_{BB} equal to 3.67 nH. For the simulations, the parameters disclosed previously in relation to FIG. 23 are also used.

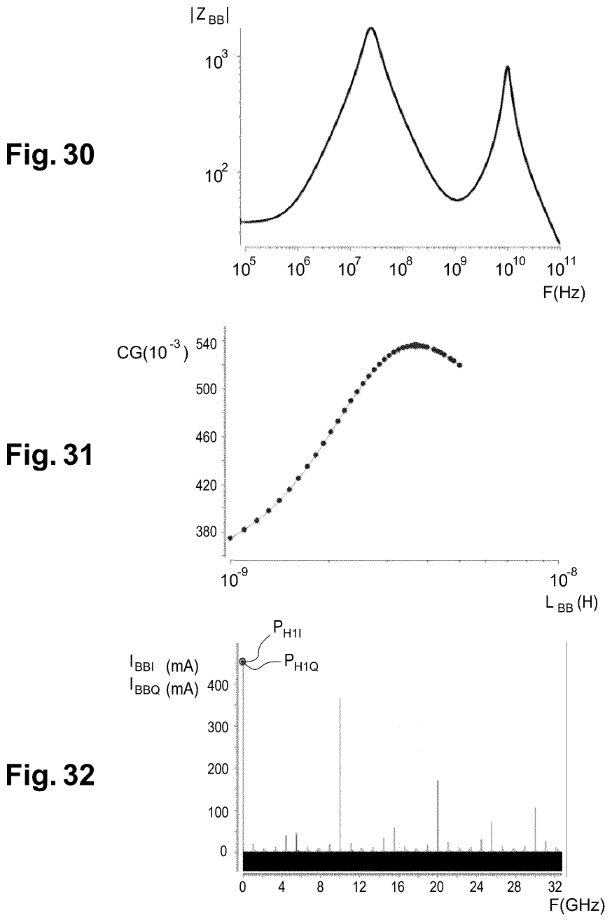

FIG. 30 shows an amplitude spectrum of the impedance Z_{BB} seen by the mixing stage 18 of the IQ mixer of FIG. 4 with the inductive blocks Brand B_{Q} having each the structure shown in FIG. 29.

FIG. 31 shows a curve of evolution of the conversion gain CG of the IQ mixer of FIG. 4, with the inductive blocks B_{I} and B_{Q} having each the structure shown in FIG. 22, with respect to the inductance L_{BB} of the inductive blocks B_{I} and B_{Q}. The maximum conversion gain CG is substantially equal to 0.536. When the inductance L_{BB} becomes high, the conversion gain for the inductive mixer 12 with the mixers M_{I} and M_{Q} having the structure shown in FIG. 27 is advantageously superior to the conversion gain for the resistive mixer.

FIG. 32 shows the spectrum of the currents I_{BBI} and I_{BBQ} supplied by the IQ mixer of FIG. 4 with the inductive blocks B_{I} and B_{Q} having each the structure shown in FIG. 29 and with the inductance L_{BB} equal to 2 nH. The spectrum of the current I_{BBI} has a peak P_{H1I} at the frequency of 1 MHz, that corresponds to the angular frequency of ωₘ, having an amplitude equal substantially to 0.454. The spectrum of the current I_{BBQ} also has a single peak P_{H1Q} at the frequency of 1 MHz, that corresponds to the angular frequency of ωₘ, having an amplitude equal substantially to 0.454.

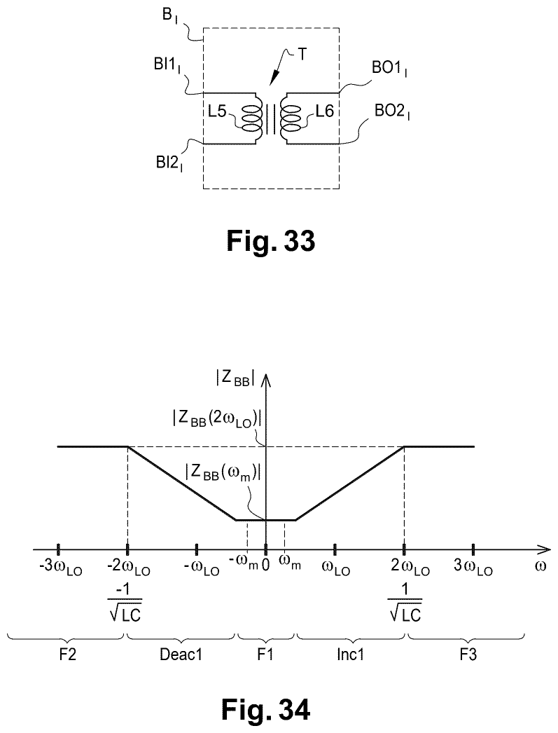

FIG. 33 is a block diagram of another embodiment of the inductive block B_{I} of the IQ mixer 12 of FIG. 4. The inductive block B_{Q} can have the same structure as the inductive block B_{I}.

The inductive block B_{I} shown in FIG. 33 comprises a transformer T comprising a primary inductor L5 having a first terminal coupled, preferably connected, to the first input BILI and a second terminal coupled, preferably connected, to the second input BI2_{I} and a secondary inductor L6 having a first terminal coupled, preferably connected, to the first output BO1_{I} and a second terminal coupled, preferably connected, to the second output BO2_{I}.

FIG. 34 shows an amplitude spectrum of the impedance Z_{BBI} Or Z_{BBQ} seen by the mixing stage of the IQ mixer 12 of FIG. 4 with the inductive blocks Brand B_{Q} having each the structure shown in FIG. 32.

The amplitude spectrum comprises: a substantially flat portion F2 for the angular frequencies inferior to −2ω_{LO}; a decreasing portion Deac1 for the angular frequency in the range from −2ω_{LO} to −ωₘ, so that the module |Z_{BB}(−2ω_{LO})| of the impedance Z_{BB} at the angular frequency of −2ω_{LO} is at least ten times superior to the module |Z_{BB}(ωₘ)| of the impedance Z_{BB} at the angular frequency of ωₘ; a substantially flat portion F1 at least for the angular frequencies in the range from −ωₘ to ωₘ; an increasing portion Inc1 for the angular frequencies in the range from ωₘ to 2ω_{LO}, so that the module |Z_{BB}(2ω_{LO})| of the impedance Z_{BB} at the angular frequency of 2ω_{LO} is at least ten times superior to the module |Z_{BB}(ωₘ)| of the impedance Z_{BB} at the angular frequency of ωₘ; and a substantially flat portion F3 for the angular frequencies superior to 2ω_{LO}.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. An IQ mixer circuit, comprising:
a direct conversion from radio frequency (RF) to baseband mixing stage comprising a first mixer and a second mixer;
a first inductive block coupled to an output of the first mixer and comprising at least a first inductive component;
a first low impedance transconductor stage at baseband coupled to an output of the first inductive block;
a second inductive block coupled to an output of the second mixer and comprising at least a second inductive component; and
a second low impedance transconductor stage at baseband coupled to an output of the second inductive block.

2. The IQ mixer circuit according to claim 1, wherein the mixing stage comprises a first input, a second input, a first output, a second output, a third output, and a fourth output, wherein the first mixer is connected to the first input, the second input, the first output, and the second output, wherein the second mixer is connected to the first input, the second input, the third output, and the fourth output, wherein the first inductive block is connected to the first output and the second output, and wherein the second inductive block is connected to the third output and the fourth output.

3. The IQ mixer circuit according to claim 2, wherein the first inductive block comprises a first inductor having first and second terminals, the first terminal being connected to the first output, and a second inductor having third and fourth terminals, the third terminal being connected to the second output.

4. The IQ mixer circuit according to claim 3, wherein the first inductive block further comprises a first capacitor connected between the second terminal and the fourth terminal.

5. The IQ mixer circuit according to claim 3, wherein the first inductive block further comprises a fourth capacitor connected between the first output and the second output.

6. The IQ mixer circuit according to claim 2, wherein the first inductive block comprises a third inductor having fifth and sixth terminals, a second capacitor connected between the first output and the fifth terminal, and a third capacitor connected between the second output and the sixth terminal.

7. The IQ mixer circuit according to claim 6, wherein the first inductive block further comprises a fourth capacitor connected between the first output and the second output.

8. The IQ mixer circuit according to claim 2, wherein the first inductive block comprises a transformer comprising a fourth inductor connected between the first output and the second output and a fifth inductor coupled with the fourth inductor.

9. The IQ mixer circuit according to claim 1, wherein the first mixer comprises:
a first MOS transistor whose drain is coupled to the first output and whose source is connected to the first input;
a second MOS transistor whose drain is connected to the second output and whose source is connected to the first input;
a third MOS transistor whose drain is connected to the first output and whose source is connected to the second input; and
a fourth MOS transistor whose drain is connected to the second output and whose source is connected to the second input.

10. The IQ mixer circuit according to claim 9, wherein the second mixer comprises:
a fifth MOS transistor whose drain is connected to the third output and whose source is connected to the first input;
a sixth MOS transistor whose drain is connected to the fourth output and whose source is connected to the first input;
a seventh MOS transistor whose drain is connected to the third output and whose source is connected to the second input; and
an eighth MOS transistor whose drain is connected to the fourth output and whose source is connected to the second input.

11. The IQ mixer circuit according to claim 1, wherein each of the first and second inductive block provides for high-pass filtering.

12. A radiofrequency receiver, comprising:
the IQ mixer circuit according to claim 1;
an antenna;
a low noise amplifier coupling the antenna to the mixing stage.
